(19) United States
(12) Patent Application Publication
(10) Pub. No.: US 2024/0342645 A1
(43) Pub. Date: Oct. 17, 2024

(54) MICROPOROUS CROSSLINKED POLYMER MEMBRANE AND PROCESS FOR FABRICATING THE SAME

(71) Applicant: SOGANG UNIVERSITY RESEARCH & BUSINESS DEVELOPMENT FOUNDATION, Seoul (KR)

(72) Inventors: Jong Suk LEE, Seoul (KR); Ju Ho SHIN, Seoul (KR); Ho Jun LEE, Seoul (KR)

(21) Appl. No.: 18/635,381

(22) Filed: Apr. 15, 2024

(30) Foreign Application Priority Data
Apr. 17, 2023 (KR) 10-2023-0049956

(51) Int. Cl. B01D 53/22; B01D 67/00; B01D 69/02; B01D 71/32; B01D 71/82

(52) U.S. Cl. CPC B01D 53/228; B01D 67/0006; B01D 69/02; B01D 71/32; B01D 71/82; B01D 2256/10; B01D 2256/24; B01D 2257/504; B01D 2323/081; B01D 2323/14; B01D 2323/219; B01D 2323/30; B01D 2325/02831; B01D 2325/02832; B01D 2325/04; B01D 2325/20; B01D 2325/28; B01D 2325/30

(57) ABSTRACT

The present disclosure relates to a highly-permeable microporous thermally crosslinked polymer membrane obtained by thermally crosslinking halogenated aromatic polymers having multiple benzene rings and a halogenated benzene ring, and a preparation method thereof. The microporous thermally crosslinked polymer membrane according to an embodiment of the present disclosure has a dramatically increased free volume, thus enabling excellent gas separation performance, particularly high gas permeability, and improved plasticization resistance, chemical resistance, and durability.

### CROSS REFERENCE TO RELATED APPLICATION(S)

This application claims priority to Korean Patent Application No. 10-2023-0049956 filed in the Korean Intellectual Property Office on Apr. 17, 2023, the disclosure of which is incorporated by reference herein in its entirety.

### TECHNICAL FIELD

The present disclosure relates to a highly-permeable microporous crosslinked polymer membrane and a preparation method thereof. Specifically, the present disclosure relates to a highly-permeable microporous polymer membrane obtained by thermally crosslinking halogenated aromatic polymers having multiple benzene rings and a halogenated benzene ring, and a preparation method thereof.

### DESCRIPTION OF THE RELATED ART

Given the emergence of severe and anomalous climate conditions attributed to global warming as a significant global concern, there exists a critical imperative for advancing the development of carbon capture, utilization, and storage (CCUS) technology. This imperative is driven by the urgent necessity to address carbon dioxide, the primary contributor to global warming. Carbon dioxide capture technology is divided into pre-combustion capture, post-combustion capture, and oxyfuel combustion technologies depending on the location of the carbon dioxide capture and separation process. Additionally, as a separation process to capture carbon dioxide, a chemical absorption process, an adsorption process, a membrane separation process, a cryogenic distillation, etc. are used. One appealing option among these separation processes is a membrane process, which driven by pressure and is environmentally friendly, avoiding phase changes and toxic substances. Additionally, it boasts high energy efficiency and a compact design, making it suitable for various industrial uses.

The membrane used in the membrane separation process is mainly a polymer membrane. The polymeric membrane has advantages in that it possesses excellent processability, thereby facilitating large-scale fabrication, and it offers economic efficiency. However, a trade-off exists between permeability and selectivity due to the gas permeation mechanism of the polymer membrane based on dissolution-diffusion, which results in a limit to the separation performance called the upper bound. When separating condensable gases such as carbon dioxide under high pressure conditions, there is a problem in that separation efficiency is significantly reduced due to plasticization of the polymer chain. Additionally, the permeability decreases significantly due to the physical aging phenomenon in which the density of the polymer membrane increases with time in order for the free volume of the glassy polymer to reach thermodynamic equilibrium.

Polymer thermal crosslinking technology is one of the easy and economical methods to improve the plasticization resistance of polymers. Organic functional groups, which generally have poor thermal stability, are activated through heat treatment and then covalent bonds between polymer chains are induced. As a result, the fluidity of the polymer chains decreases, and the change in free volume becomes insignificant despite the adsorption of high-pressure condensable gas thereto.

For example, International Application Publication WO 2010/005734 discloses a method in which a first polymer, which includes a first repeating unit including a carboxyl group, is crosslinked to a second polymer formed from a second repeating unit, thus enabling the crosslinking of the first polymer to the second polymer without forming an ester group. International Application Publication WO 2015/129925 discloses a method for thermal crosslinking of polymers of intrinsic microporosity (PIM) under controlled oxygen concentration. International Application Publication WO 2010/110994 discloses a new type of high-performance polymer membrane prepared from an aromatic polyimide membrane by heat treatment and crosslinking and a method of preparing and using such a membrane. This polymer membrane was prepared from an aromatic polyimide membrane by heat treatment under an inert atmosphere followed by crosslinking, preferably using a UV radiation source. U.S. Patent Application Publication No. US 2015/0000528 discloses a crosslinked and thermally rearranged poly(benzoxazole-co-imide) obtained by transesterification crosslinking between an ortho-hydroxy polyimide copolymer and a diol compound followed by thermal rearrangement, a gas membrane, and a method for preparing the same.

A microporous polymer refers to a polymer having micropores smaller than 2 nm. Microporous polymers have a non-crosslinked, linear polymer structure and consist of a rigid and significantly twisted polymer main chain. Therefore, it has a low chain packing density, and since it has chains with suppressed movement, it has microporosity due to a high fractional free volume. It is prepared through the introduction of a monomer with a ladder-shaped main chain and a monomer with a spiro structure.

Meanwhile, a thermally rearranged microporous polymer was developed from polyimide in which a non-porous hydroxy group was introduced at the ortho position of the imide through thermal conversion at 400° C. to 450° C. International Application Publication WO 2009/113747 discloses a method for producing a benzoxazole-based polymer by thermal rearrangement, a benzoxazole-based polymer prepared by the method, and a gas membrane including the polymer.

### PRIOR ART DOCUMENT

### [Patent Document]

(Patent Document 1) WO 2010/005734
(Patent Document 2) WO 2015/129925
(Patent Document 3) WO 2010/110994
(Patent Document 4) US 2015/0000528
(Patent Document 5) WO 2009/113747

### SUMMARY

An object of the present disclosure is to provide a microporous crosslinked membrane that exhibits excellent gas permeability.

Another object of the present disclosure is to provide a method for preparing a microporous crosslinked membrane.

Still another object of the present disclosure is to provide a method for separating mixed gas using a microporous crosslinked membrane.

According to one embodiment of the present disclosure, there is provided a microporous crosslinked polymer membrane, which includes a thermally crosslinked product of halogenated aromatic polymers, including a repeating unit having (a) a residue of an aldehyde or ketone having a halogenated aromatic ring; and (b) a residue of a deactivated aromatic hydrocarbon having multiple aromatic rings.

According to another embodiment of the present disclosure, there is provided a method for preparing a microporous crosslinked polymer membrane, which includes (1) dissolving, in a solvent, the halogenated aromatic polymer, including a repeating unit having (a) a residue of an aldehyde or ketone having a halogenated aromatic ring; and (b) a residue of a deactivated aromatic hydrocarbon having multiple aromatic rings; (2) forming the polymer solution obtained in the step (1) above into a form of a membrane and then removing the solvent; and (3) thermally crosslinking the membrane obtained in the step (2) above at a temperature of 430° C. to 520° C.

According to still another embodiment of the present disclosure, there is provided a method for separating gas, which includes allowing a mixed gas including at least one gas selected from the group consisting of hydrogen, carbon dioxide, nitrogen, methane, ethane, ethylene, propane, and propylene to pass through the microporous crosslinked polymer membrane to thereby partially separate this at least one gas selected from the group consisting of hydrogen, carbon dioxide, nitrogen, methane, ethane, ethylene, propane, and propylene.

The microporous crosslinked polymer membrane according to an embodiment of the present disclosure, in which a halogenated aromatic polymer is crosslinked, has a dramatically increased free volume, and thus can exhibit excellent gas permeability for hydrogen, carbon dioxide, nitrogen, methane, ethane, ethylene, propane, and propylene.

The microporous crosslinked polymer membrane according to an embodiment of the present disclosure, due to the crosslinked polymer structure, can exhibit improved plasticization resistance, chemical resistance, durability, and aging resistance.

### BRIEF DESCRIPTION OF THE DRAWINGS

FIG. 1 is a schematic diagram of an apparatus for thermally crosslinking a precursor membrane.

FIG. 2 shows (a) thermogravimetric analysis (TGA) of pTPPFA and of pTPTFA precursors measured under the conditions of N₂ and 10° C./min; (b) X-ray photoelectron analysis (XPS) of pTPPFA before and after heat treatment; (c) Raman spectrum of pTPPFA before and after heat treatment; and (d) X-ray diffraction (XRD) spectrum of pTPPFA before and after heat treatment.

FIG. 3 shows (a) N₂ adsorption isotherm of pTPPFA and thermally treated pTPPFA measured at −196° C.; (b) CO₂ adsorption curve of pTPPFA and thermally treated pTPPFA measured at 0° C.; (c) pore size distribution of thermally treated pTPPFA calculated by the NLDFT model using N₂ adsorption results at −196° C.; and (d) pore size distribution of thermally treated pTPPFA calculated by the NLDFT model using CO₂ adsorption results at 0° C.

FIG. 4 shows (a) H₂, CO₂, N₂, and CH₄ single gas permeability, and (b) H₂/N₂, H₂/CH₄, CO₂/N₂, and CO₂/CH₄ selectivity for pTPPFA and thermally treated pTPPFA measured under conditions of 1 atm and 35° C.; and (c) H₂, CO₂, N₂, and CH₄ single gas permeability and (d) H₂/N₂, H₂/CH₄, CO₂/N₂, and CO₂/CH₄ selectivity for pTPTFA and pTPPFA thermally treated at 500° C.

FIG. 5 shows (a) CO₂/N₂ separation performance and (b) CO₂/CH₄ separation performance of pTPPFA thermally treated at 500° C. measured at 250K, 273K, 293K, 308K, and 1 atm; (c) long-term stability evaluation of pTPPFA thermally treated at 500° C. measured at 35° C. for about 10,000 hours; (d) CO₂ adsorption isotherm of pTPPFA thermally treated at 500° C. measured at 273K, 298K, and 308K; (e,f) Mixed gas CO₂/CH₄ (50/50 mol) separation performance as function of a total pressure varying from 30 to 700 psi of (e) pTPPFA, and (f) pTPPFA thermally treated at 500° C.

FIG. 6 shows (a) CO₂/N₂ and (b) CO₂/CH₄ separation performance of pTPPFA and thermally treated pTPPFA measured under the conditions of 1 atm and 35° C. Note that separation performance as function of temperature varying from 253 to 308K of pTPPFA thermally treated at 500° C. is measured at 1 atm; and (c) C₂H₄/C₂H₆ and (d) C₃H₆/C₃H₈ separation performance of a thermally crosslinked polymer membrane measured under the conditions of 2 atm and 35° C.

### DETAILED DESCRIPTION

Hereinafter, the present disclosure is explained in more detail.

### Microporous Crosslinked Polymer Membrane

According to one embodiment of the present disclosure, there is provided a microporous crosslinked polymer membrane, which includes a thermally crosslinked product of halogenated aromatic polymers, including a repeating unit having (a) a residue of an aldehyde or ketone having a halogenated aromatic ring; and (b) a residue of a deactivated aromatic hydrocarbon having multiple aromatic rings.

The microporous crosslinked polymer membrane according to an embodiment of the present disclosure includes a thermally crosslinked product of halogenated aromatic polymers.

In a specific embodiment of the present disclosure, a halogenated aromatic polymer includes a repeating unit having (a) a residue of an aldehyde or ketone having a halogenated aromatic ring; and (b) a residue of a deactivated aromatic hydrocarbon having multiple aromatic rings.

In a specific embodiment of the present disclosure, the repeating unit has (a) a residue of an aldehyde or ketone having a halogenated aromatic ring. The residue (a) may be derived from an aldehyde or ketone having a halogenated aromatic ring. In particular, the aldehyde or ketone having a halogenated aromatic ring may refer to an aldehyde or ketone that has at least one aromatic ring in which at least one halogen group substituted in the aromatic ring. In particular, the halogen group may be selected from fluorine (F), chlorine (Cl), bromine (Br), and iodine (I). Additionally, this aromatic ring may include a substituent other than the halogen group.

In a preferred embodiment of the present disclosure, the aldehyde or ketone having a halogenated aromatic ring may include at least one compound selected from the compounds represented by the formulas below, but are not particularly limited thereto.

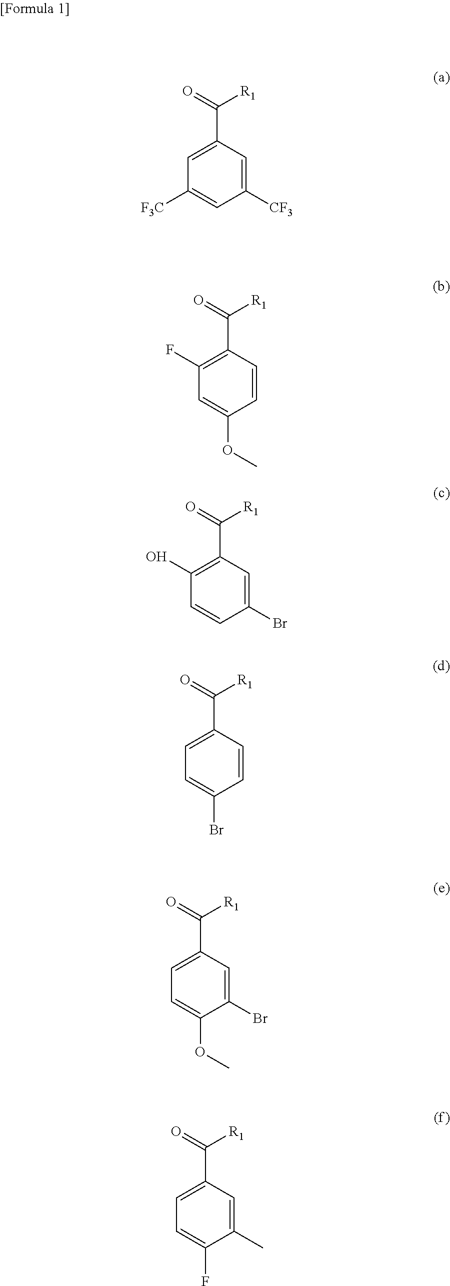

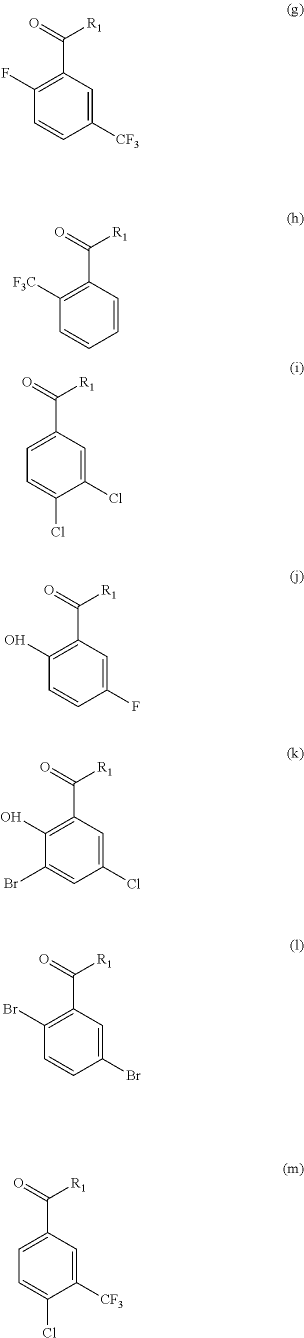

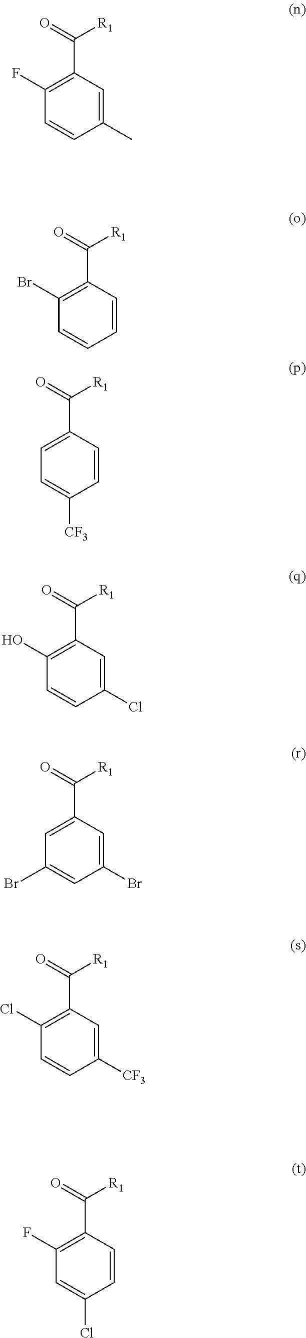

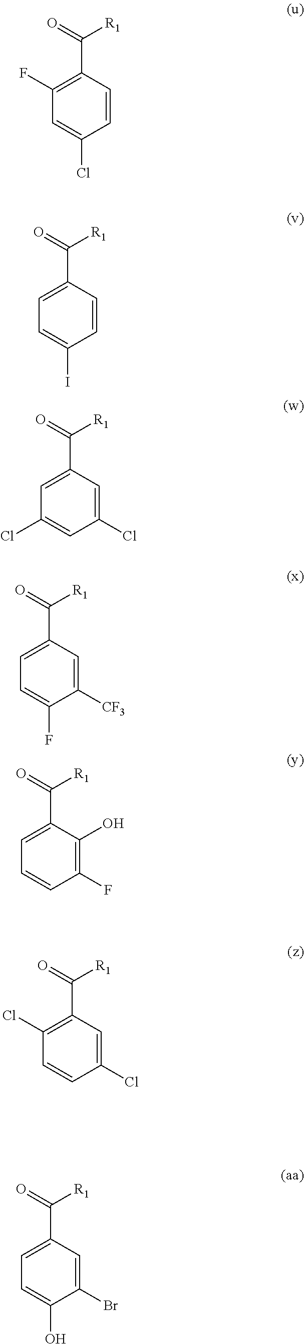

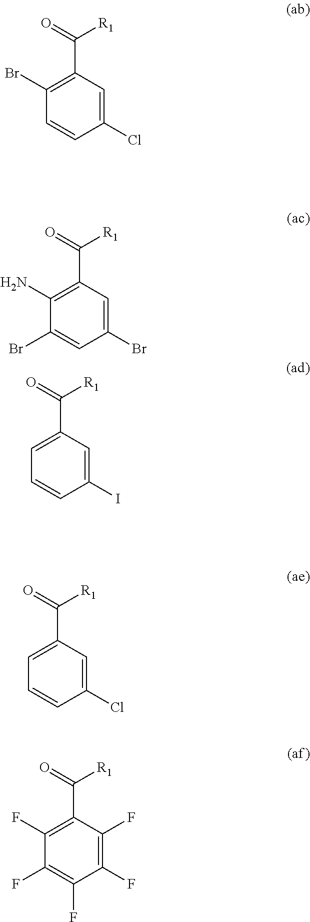

In Formula 1 above, R₁ may be C₁₋₂₀ alkyl substituted or unsubstituted with hydrogen or halogen. Preferably R₁ may be hydrogen or trifluoromethyl.

In a preferred embodiment of the present disclosure, the aldehyde or ketone having a halogenated aromatic ring may include octafluoroacetophenone where R₁ is trifluoromethyl in Formula 1(af) above. More preferably, the aldehyde or ketone having a halogenated aromatic ring may be octafluoroacetophenone where R₁ is trifluoromethyl in Formula 1(af) above.

In a specific embodiment of the present disclosure, the repeating unit of a halogenated aromatic polymer has (b) a residue of a deactivated aromatic hydrocarbon having multiple aromatic rings. The residue (b) may be derived from a deactivated aromatic hydrocarbon having multiple aromatic rings. In particular, the deactivated aromatic hydrocarbon having multiple aromatic rings may mean a deactivated aromatic hydrocarbon having two or more aromatic rings.

In a preferred embodiment of the present disclosure, the deactivated aromatic hydrocarbon having multiple aromatic rings may include at least one compound selected from the compounds having the formulas below, but is not particularly limited thereto.

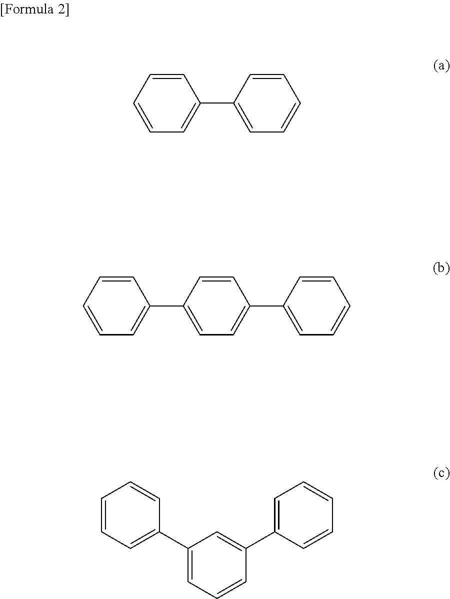

In a preferred embodiment of the present disclosure, the deactivated aromatic hydrocarbon having multiple aromatic rings may include para-terphenyl in Formula 2(b) above. More preferably, the deactivated aromatic hydrocarbon having multiple aromatic rings may be the para-terphenyl of Formula 2(b) above.

In a preferred embodiment of the present disclosure, the halogenated aromatic polymer may have the structure of Formula 3 below.

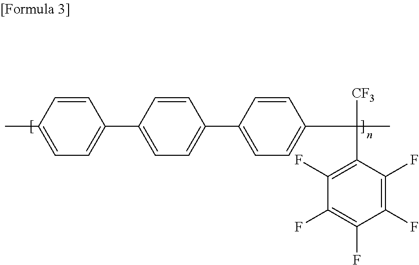 [SMILES: Cc1ccc(-c2ccc(-c3ccc(C(C)(c4c(F)c(F)c(F)c(F)c4F)C(F)(F)F)cc3)cc2)cc1]

In Formula 3 above, n may be 50 to 500.

In a specific embodiment of the present disclosure, the halogenated aromatic polymer may have a linear structure, but is not particularly limited thereto.

In a specific embodiment of the present disclosure, a halogenated aromatic polymer can be prepared by polymerizing an aldehyde or ketone having a halogenated aromatic ring and a deactivated aromatic hydrocarbon having multiple aromatic rings using a known method. For example, the halogenated aromatic polymer may be prepared by subjecting an aldehyde or ketone having a halogenated aromatic ring and a deactivated aromatic hydrocarbon having multiple aromatic rings to a Friedel-Crafts condensation polymerization reaction in the presence of a super-acidic catalyst such as trifluoromethanesulfonic acid (see Reference M. Teresa Guzman-Gutierrez et al., J. of Membrane Sci., 385-386, 277-284 (2011)).

In the polymerization of an aldehyde or ketone having a halogenated aromatic ring and a deactivated aromatic hydrocarbon having multiple aromatic rings, these two compounds can react stoichiometrically, but are not particularly limited to thereto.

The microporous crosslinked polymer membrane according to an embodiment of the present disclosure includes a thermally crosslinked product of halogenated aromatic polymers. In particular, as described later, the thermally crosslinked product of halogenated aromatic polymers may be a product obtained by thermally crosslinking the halogenated aromatic polymers at a temperature of 430° C. to 520° C., preferably 440° C. to 510° C., and more preferably 450° C. to 500° C.

In the microporous crosslinked polymer membrane according to an embodiment of the present disclosure, the specific surface area calculated using the nitrogen (N₂) adsorption isotherm measured at −196° C. and the Brunauer-Emmett-Teller (BET) equation may be 520 m²/g to 1,000 m²/g. In a specific embodiment of the present disclosure, the specific surface area may be 530 m²/g to 800 m²/g, 540 m²/g to 790 m²/g, or 540 m²/g to 785 m²/g.

In the microporous crosslinked polymer membrane according to an embodiment of the present disclosure, the carbon dioxide (CO₂) adsorption amount calculated from the carbon dioxide (CO₂) adsorption isotherm measured at 0° C. may be 35 cm³/g to 80 cm³/g. In a specific embodiment of the present disclosure, the carbon dioxide (CO₂) adsorption amount may be 40 cm³/g to 75 cm³/g.

In the microporous crosslinked polymer membrane according to an embodiment of the present disclosure, the total pore volume calculated using the nitrogen (N₂) adsorption isotherm measured at −196° C. and the non-local density functional theory (NLDFT) model is 0.20 cm³/g to 0.40 cm³/g. In a specific embodiment of the present disclosure, the total pore volume may be 0.20 cm³/g to 0.35 cm³/g, 0.21 cm³/g to 0.35 cm³/g, or 0.22 cm³/g to 0.32 cm³/g.

The microporous crosslinked polymer membrane according to an embodiment of the present disclosure may have an average thickness of 60 μm to 100 μm. Preferably, the microporous crosslinked polymer membrane may have an average thickness of 60 μm to 80 μm, 80 μm to 100 μm, or 70 μm to 80 μm.

In the microporous crosslinked polymer membrane according to an embodiment of the present disclosure, the micropore volume calculated using the nitrogen (N₂) adsorption isotherm measured at −196° C. and the non-local density functional theory (NLDFT) model may be 0.10 cm³/g to 0.30 cm³/g. In a specific embodiment of the present disclosure, the micropore volume may be 0.12 cm³/g to 0.30 cm³/g, 0.12 cm³/g to 0.28 cm³/g, or 0.13 cm³/g to 0.27 cm³/g. In particular, the micropore may refer to a pore with an average diameter of 2 nm or less.

In the microporous crosslinked polymer membrane according to an embodiment of the present disclosure, under the conditions of 1 atm and 35° C., the hydrogen permeability may be 4,000 Barrer to 16,000 Barrer, the carbon dioxide permeability may be 10,000 Barrer to 31,000 Barrer, the nitrogen permeability is 800 Barrer to 21,000 Barrer, and the methane permeability may be 500 Barrer to 2,000 Barrer; under the conditions of 1 atm and −20° C., the carbon dioxide permeability may be 7,000 Barrer to 9,000 Barrer, the nitrogen permeability may be 100 Barrer to 150 Barrer, and the methane permeability may be 50 Barrer to 75 Barrer; and under the conditions of 2 atm and 35° C., the ethylene permeability may be 1,200 Barrer to 4,000 Barrer, the ethane permeability may be 400 Barrer to 1,500 Barrer, the propylene permeability may be 2,000 Barrer to 3,000 Barrer, and the propane permeability may be 250 Barrer to 400 Barrer.

In the microporous crosslinked polymer membrane according to an embodiment of the present disclosure, under the conditions of 1 atm and 35° C., the carbon dioxide/hydrogen selectivity may be 1.0 to 3.0, the carbon dioxide/nitrogen selectivity may be 12.0 to 18.0, and the carbon dioxide/methane selectivity may be 12.0 to 20.0; under the conditions of 1 atm and −20° C., the carbon dioxide/nitrogen selectivity may be 45 to 90 and the carbon dioxide/methane selectivity may be 93 to 200; and under the conditions of 2 atm and 35° C., the ethylene/ethane selectivity may be 2.0 to 5.0 and the propylene/propane selectivity may be 6.0 to 10.0.

### Preparation of Microporous Crosslinked Polymer Membrane

According to an embodiment of the present disclosure, there is provided a method for preparing a microporous crosslinked polymer membrane, which includes (1) dissolving, in a solvent, the halogenated aromatic polymer, including a repeating unit having (a) a residue of an aldehyde or ketone having a halogenated aromatic ring; and (b) a residue of a deactivated aromatic hydrocarbon having multiple aromatic rings; (2) forming the polymer solution obtained in the step (1) above into a form of a membrane and then removing the solvent; and (3) thermally crosslinking the membrane obtained in the step (2) above at a temperature of 430° C. to 520° C.

### Step (1)

In step (1), the halogenated aromatic polymer, which includes a repeating unit having (a) a residue of an aldehyde or ketone having a halogenated aromatic ring and (b) a residue of a deactivated aromatic hydrocarbon having multiple aromatic rings, is dissolved in a solvent.

The halogenated aromatic polymer, which includes a repeating unit having (a) a residue of an aldehyde or ketone having a halogenated aromatic ring and (b) a residue of a deactivated aromatic hydrocarbon having multiple aromatic rings, is as described in the microporous crosslinked polymer membrane above.

In a specific embodiment of the present disclosure, the solvent is not particularly limited as long as it can dissolve the halogenated aromatic polymer and can be removed thereafter. Preferably, this solvent may be selected from the group consisting of N-methyl-2-pyrrolidone (NMP), tetrahydrofuran (THF), methylene chloride (MC), chloroform; CHCl₃), toluene, and a mixture thereof.

In a specific embodiment of the present disclosure, the weight ratio of the solvent to the total weight of the halogenated aromatic polymer may be in the range of 1:99 to 30:70. Preferably, the weight ratio of the solvent to the total weight of the halogenated aromatic polymer may be in the range of 1:99 to 30:70, 1:99 to 20:80, 1:99 to 10:90, 2:98 to 10:90, or 3:97 to 10:90.

The temperature and time for dissolving the halogenated aromatic polymer in the above solvent are not particularly limited. For example, the halogenated aromatic polymer may be dissolved in the solvent at room temperature for 12 to 24 hours.

### Step (2)

In step (2), the polymer solution obtained in the step (1) above in molded into a membrane, and then the solvent is removed.

The method of molding the polymer solution obtained in the step (1) above into a membrane is not particularly limited. As a specific embodiment, the polymer solution obtained in the step (1) above is poured into a glass petri dish and then dried for about 24 hours to obtain a flat-type precursor membrane. In particular, in order to facilitate evaporation of the solvent, it is preferable to dry the glass petri dish in a vacuum oven set at room temperature for 24 hours, remove the solvent using nitrogen, and then further dry the glass petri dish in a vacuum oven at about 120° C. for 24 hours.

The average thickness of the dried precursor membrane obtained in the step (2) may be 70 μm to 100 μm, but is not particularly limited to this thickness.

### Step (3)

In the step (3) above, the precursor membrane obtained in the step (2) above is thermally crosslinked at a temperature of 430° C. to 520° C.

In a specific embodiment of the present disclosure, the thermal crosslinking of the precursor membrane is performed at a temperature of 430° C. to 520° C. Preferably, the thermal crosslinking of the precursor membrane may be performed at a temperature of 440° C. to 510° C. More preferably, the thermal crosslinking of the precursor membrane may be performed at a temperature of 450° C. to 500° C. When the thermal crosslinking temperature exceeds 520° C., the polymer may be carbonized, whereas when the thermal crosslinking temperature is lower than 430° C., crosslinking may not sufficiently occur.

In a specific embodiment of the present disclosure, the thermal crosslinking may be performed for 0.5 to 4 hours. More specifically, the thermal crosslinking may be performed for 0.5 to 3 hours, and more specifically 1 to 2 hours. When the thermal crosslinking time is less than the above range, crosslinking may not occur sufficiently.

In a specific embodiment of the present disclosure, the thermal crosslinking may be performed in an inert gas atmosphere. More specifically, the thermal crosslinking may be performed in an argon gas atmosphere, but is not particularly limited thereto.

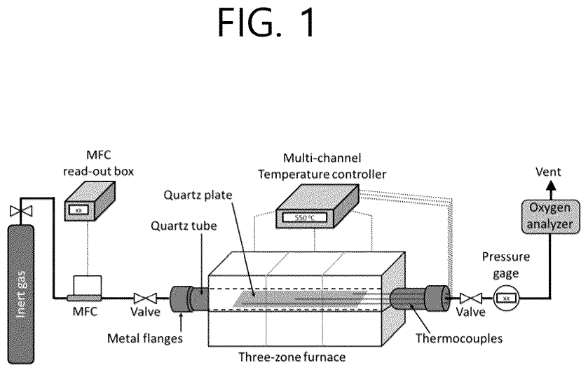

Referring to FIG. 1, the thermal crosslinking process of the precursor membrane will be described. The dried precursor membrane is placed on a quartz plate in a quartz tube of a thermal treatment device. Next, the temperature is raised to a temperature at which thermal crosslinking is possible while continuously injecting an inert gas such as argon. Preferably, during the thermal crosslinking, the temperature is raised at a rate of 13.3° C./min from 50° C. to 250° C. and 3.85° C./min from 250° C. to the thermal crosslinking temperature, and it is preferable to maintain the final thermal crosslinking temperature for 2 hours, but this thermal crosslinking condition is not particularly limited thereto.

As a result of the thermal crosslinking in the step (3) above, a microporous crosslinked polymer membrane according to an embodiment of the present disclosure may be obtained.

### Microporous Crosslinked Polymer Membrane for Gas Separation Application

According to still another implementation of the present disclosure, there is provided a method for separating gas, which comprises allowing a mixed gas including at least one gas selected from the group consisting of hydrogen, carbon dioxide, nitrogen, methane, ethane, ethylene, propane, and propylene to pass through a microporous crosslinked polymer membrane to thereby partially separate this at least one gas selected from the group consisting of hydrogen, carbon dioxide, nitrogen, methane, ethane, ethylene, propane, and propylene.

In a specific embodiment of the present disclosure, the above method may include a step of separating one or more gases from a mixture of two or more gases. For example, this method may include a step, in which from a mixed gas selected from the group consisting of combinations of hydrogen/carbon dioxide, carbon dioxide/nitrogen, carbon dioxide/methane, ethylene/ethane, and propylene/propane, at least one gas among them is partially separated, but is not particularly limited to these.

### EXAMPLES

Hereinafter, the present disclosure will be described in more detail through examples. However, the examples below are only intended to illustrate the present disclosure, and the scope of the present disclosure is not limited to these.

### Preparation Example 1

### (1) Preparation of Halogenated Aromatic Polymer Crosslinked Membrane

Octafluoroacetophenone (3.96 g, 15.0 mmol), para-terphenyl (3.45 g, 15.0 mmol), and trifluoromethane sulfonic acid (1.3 mL) were added into a 10 mL three-neck round bottom flask and were reacted at room temperature for 16 hours to obtain a transparent, viscous, orange solution. This solution was slowly poured into water to obtain white fibers, which were washed with water and extracted with hot methanol to obtain 7.03 g of para-terphenyl-perfluorinated trifluoroacetophenone (pTPPFA) polymer.

### (2) Preparation of Halogenated Aromatic Precursor Membrane

pTPPFA and tetrahydrofuran (THF) obtained above were mixed at a 5:95 weight ratio and the mixture was stirred at room temperature for 24 hours to prepare a polymer solution with a total weight of 2 g. This polymer solution was poured into a glass petri dish with a diameter of 30 mm in a glove box saturated with THF. After 24 hours, all saturated THE was removed using nitrogen. Thereafter, the resultant was dried in a vacuum oven at 120° C. for 24 hours to obtain a precursor membrane with a thickness of 80 μm to 90 μm.

### (3) Thermal Crosslinking of Halogenated Aromatic Precursor Membrane

pTPPFA precursor membrane obtained in Preparation Example 1 was cut to a diameter of 20 mm using a die cutter, and then it was placed on a crystal plate (United Silica Products, USA) in a crystal tube (MTI, USA) of the heat treatment device in FIG. 1. High-purity argon was flowed through the crystal tube at a flow rate of 400 cm³/min for more than 6 hours to maintain the residual oxygen concentration inside the crystal tube at 1 ppm or less. Thermally crosslinked membrane was prepared by heat treatment of the precursor membrane under the heat treatment conditions shown in Table 1 below. The average thickness of the prepared crosslinked polymer membrane was 67 μm.

In the case of a thermally treated polymer membrane, the final temperature maintained was indicated after the abbreviation. For example, pTPPFA membrane with a final holding temperature of 500° C. was indicated as pTPPFA-500.

TABLE 1

| Initial Temperature | Final Temperature | Temperature Increase Rate |
|---|---|---|
| (° C.) | (° C.) | (° C./min) |
| 50 | 250 | 13.3 |
| 250 | 500 | 3.85 |
| 400, 450, or 500 | 400, 450, or 500 | maintained for 2 hours |

### Preparation Example 2: Preparation of Non-Halogenated Aromatic Polymer Membrane

### (1) Preparation of Non-Halogenated Aromatic Polymer

2,2,2-trifluoroacetophenone (2.61 g, 15.0 mmol), para-terphenyl (3.45 g, 15.0 mmol), trifluoromethane sulfonic acid (16 mL), and dichloromethane (14 mL) were added into a 100 mL three-neck round bottom flask and were reacted at 4° C. for 72 hours to obtain a viscous dark blue precipitate. The precipitate was washed with methanol and then extracted with hot methanol to obtain 5.82 g of para-terphenyl-trifluoroacetophenone (pTPTFA) polymer.

### (2) Preparation of Non-Halogenated Aromatic Precursor Membrane

The precursor membrane was prepared in the same manner as in Preparation Example 1(2), except that pTPTFA polymer was used instead of pTPPFA polymer.

### (3) Heat Treatment of Non-Halogenated Aromatic Precursor Membrane

pTPTFA-500 membrane was prepared in the same manner as in Preparation Example 1 (3).

### Experimental Example 1: Change in Chemical Structure of Precursor Membrane According to Heat Treatment Temperature

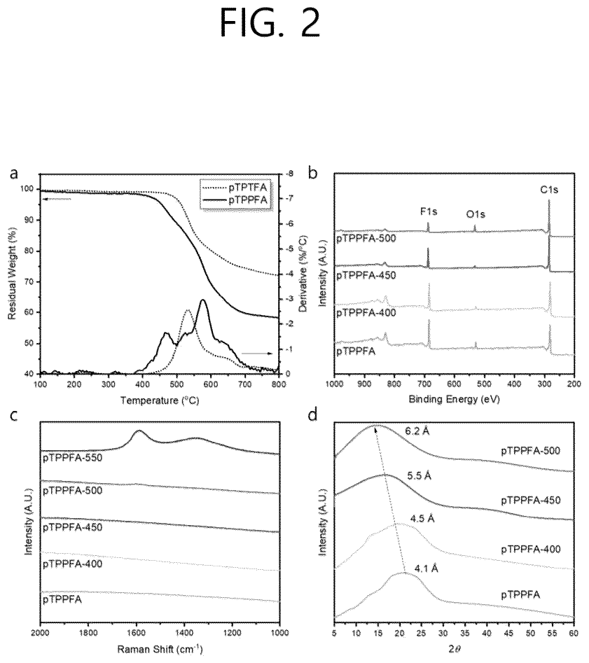

FIG. 2(a) is a thermogravimetric analysis graph to evaluate the thermal stability of pTPPFA precursor membrane in Preparation Example 1 and pTPTFA precursor membrane in Preparation Example 2.

PTPTFA precursor membrane of Preparation Example 2, which has a phenyl-structured side chain, began thermal decomposition at 440° C. This is the temperature at which thermal decomposition of the side chain trifluoromethyl structure begins. From 530° C., the main chain of pTPTFA was decomposed and carbonization occurred. In contrast, pTPPFA precursor membrane of Preparation Example 1, which has a pentafluorophenyl side chain, began to show a decrease in weight at 380° C. This is understood as the temperature at which the crosslinking reaction begins due to thermal decomposition of the fluorine of pentafluorophenyl. The change in weight showed a peak at 470° C. It can be seen that in the temperature range of 440° C. to 470° C., the crosslinking due to thermal decomposition of fluorine and the thermal decomposition of the trifluoromethyl side chain structure actively occur simultaneously, thereby forming a thermally crosslinked polymer membrane. The weight of pTPPFA precursor membrane continued to decrease from 530° C. and carbonization, which decomposes the main chain thereof, began to occur.

FIG. 2(b) shows the results of X-ray photoelectron analysis to analyze the components of the precursor membrane and the thermally crosslinked polymer membrane of Preparation Example 1.

The precursor membrane in Preparation Example 1 includes 22.6 at % (atomic percent) of fluorine atoms. As shown in Table 2 below, it was confirmed that when the precursor membrane was heat-treated at 400° C., 450° C., and 500° C., respectively, the proportion of fluorine atoms was decreased to 17.4 at %, 14.3 at %, and 9.3 at % as the temperature increased. In particular, the F/C ratio, which is the ratio of fluorine to carbon, was decreased from 0.29 before heat treatment to 0.1 after heat treatment at 500° C. This is understood to be because the fluorine included in the side chain of pTPPFA polymer was thermally decomposed.

TABLE 2

| | Composition of Components | | |
|---|---|---|---|
| Sample | C (%) | F (%) | F/C Ratio |
| pTPPFA | 77.4 | 22.6 | 0.29 |
| pTPPFA-400 | 82.6 | 17.4 | 0.21 |
| pTPPFA-450 | 85.7 | 14.3 | 0.17 |
| pTPPFA-500 | 90.9 | 9.3 | 0.10 |

FIG. 2(c) shows the results of Raman spectroscopy performed to check whether or not the thermally crosslinked polymer membrane of Preparation Example 1 is carbonized.

Since a general carbon molecular sieve uses a hexagonal lattice of sp²-bonded carbon as its basic constituting unit, the G band due to the sp² bond of carbon located at 1,585 cm-1 and the D band, which is recognized to be a disordered band originating in structural defects of carbon molecular sieve, appear around 1,350 cm⁻¹. As can be seen from FIG. 2(c), in the case of the membrane obtained by the heat treatment of pTPPFA precursor membrane in Preparation Example 1 at 550° C., both G and D bands were present. Therefore, it is understood that pTPPFA-550 membrane is a carbon molecular sieve membrane. In contrast, pTPPFA-400, pTPPFA-450, and pTPPFA-500 membranes in Preparation Example 1 did not show G and D bands as in the precursor membrane, and through this, it was confirmed that pTPPFA membranes were not carbonized under the heat treatment conditions below 500° C. for a certain period of time (e.g., 2 hours). As such, it is understood that these membranes would have a thermally crosslinked structure that is different from a carbon molecular sieve.

FIG. 2(d) is an X-ray diffraction spectrum of a thermally crosslinked polymer membrane of Preparation Example 1.

In the case of pTPPFA precursor membrane of Preparation Example 1, it has an amorphous structure and showed a wide peak at a diffraction angle (2θ) of 20.80°, which corresponds to an interchain d-spacing of 4.1 Å. In contrast, as the heat treatment temperature of pTPPFA precursor membrane increased to 400° C., 450° C., and 500° C., the interchain lattice spacing increased to 4.5 Å, 5.5 Å, and 6.2 Å, whereas the corresponding diffraction angles was decreased to 20.06°, 16.68°, and 14.72°, respectively. This is understood to be an increase in the lattice spacing between chains due to thermal crosslinking caused by thermal decomposition of fluorine.

### Experimental Example 2: Analysis of Micropore Structure According to Heat Treatment Temperature of Thermally Crosslinked Polymer Membrane

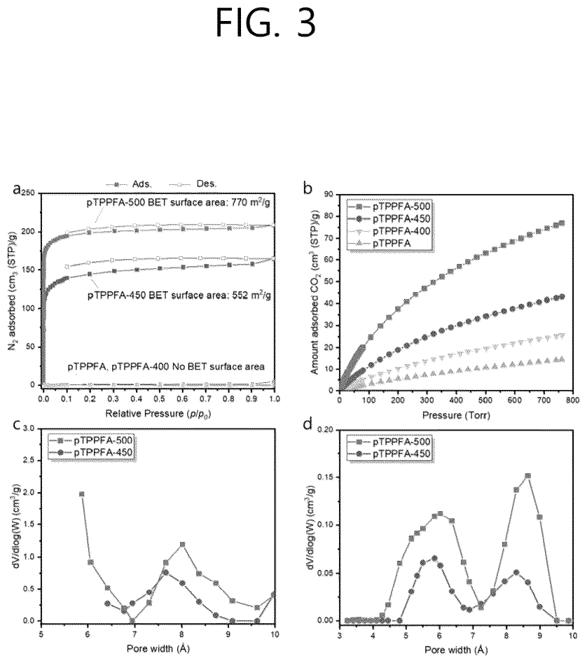

FIG. 3(a) is a graph showing the nitrogen (N₂) adsorption isotherm measured at −196° C. and the specific surface area of the thermally crosslinked polymer membrane of Preparation Example 1 calculated using the BET equation.

pTPPFA precursor membrane and pTPPFA-400 membrane in Preparation Example 1 showed minimal of N₂ adsorption, indicating a non-porous structure for pTPPFA and pTPPFA-400. In contrast, pTPPFA-450 and pTPPFA-500 exhibited significantly high N₂ adsorption at low relative pressure (p/p₀<0.1). According to the IUPAC definition, their N₂ adsorption isotherms displayed characteristics of type I microporous materials, confirming that pTPPFA thermally treated at 450° C. and 500° C. qualifies as a microporous material. It is understood that the hysteresis phenomenon that appears during N₂ desorption occurs because the gaps between the pulverized samples during the adsorption experiment form mesopores. The BET specific surface areas of pTPPFA-450 and pTPPFA-500 membranes calculated using the relative pressure range of 0.001 to 0.1 of the N₂ adsorption isotherm were 770 m²/g and 552 m²/g, respectively.

FIG. 3(b) shows a CO₂ adsorption isotherm of the thermally crosslinked polymer membrane of Preparation Example 1 measured at 0° C. As the heat treatment temperature increased, the amount of CO₂ adsorption also increased. This trend aligns with the observed increase in BET specific surface area resulting from the formation of a microporous structure through thermal crosslinking. Specifically, the amount of CO₂ adsorption of pTPPFA-450 and pTPPFA-500 membranes was 43 cm³(STP)/g and 75 cm³(STP)/g, respectively.

FIG. 3(c) shows a graph showing the nitrogen (N₂) adsorption isotherm measured at −196° C. and the micropore distribution of the thermally crosslinked polymer membrane of Preparation Example 1 calculated using the non-local density functional theory (NLDFT) model. The total pore volumes of pTPPFA-450 and pTPPFA-500 membranes were 0.23 cm³/g and 0.30 cm³/g, respectively, and among which the micropore volumes were 0.14 cm³/g and 0.26 cm³/g, respectively.

FIG. 3(d) shows a micropore distribution of the thermally crosslinked polymer membrane in Preparation Example 1 calculated using the CO₂ adsorption isotherm measured at 0° C. and the NLDFT model. As the heat treatment temperature increased, the formation of micropores (pore width <10 Å) was more pronounced. These results indicate that when pTPPFA was heat-treated to 450° C. to 500° C., a microporous structure was formed through thermal crosslinking.

### Experimental Example 3: Gas Separation Performance of Thermally Crosslinked Polymer Membrane

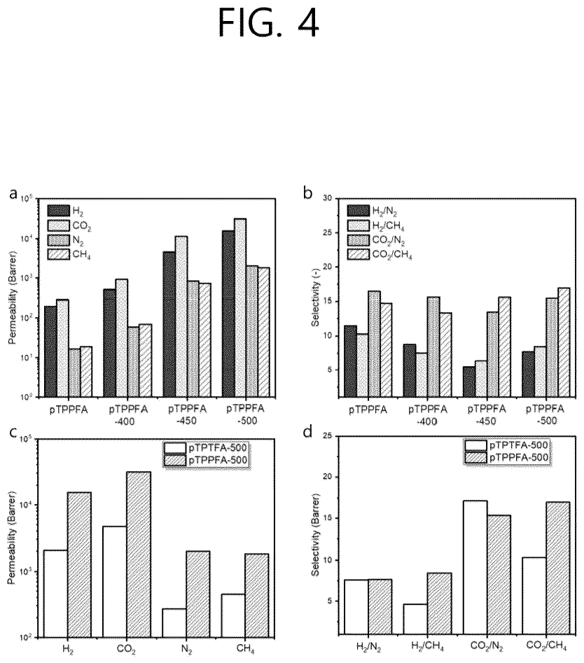

The gas separation performances of the precursor membrane and the microporous thermally crosslinked polymer membrane obtained in Preparation Example 1 and Preparation Example 2 were evaluated using a light gases (H₂, CO₂, N₂, CH₄) and a hydrocarbons (C₂C₄, C₂H₆, C₃H₆, and C₃H₈). These tests were conducted under specific conditions: 1 atm for light gases and 2 atm for hydrocarbons, with a temperature of 35° C. The results are shown in FIG. 4 and Tables 3 and 4.

As the heat treatment temperature of pTPPFA precursor membrane of Preparation Example 1 increased, the permeability for all gases significantly increased. While there was no significant change in selectivity for the gas combinations of CO₂/H₂, CO₂/N₂, and CO₂/CH₄, the selectivity for the gas combinations of C₂H₄/C₂H₆ and C₃H₆/C₃H₈ with a relatively large molecular size slightly increased.

Meanwhile, as can be seen from FIGS. 4(c) and 4(d) comparing pTPPFA-500 membrane of Preparation Example 1 and pTPTFA-500 membrane of Preparation Example 2, higher gas permeability was observed when pTPPFA precursor membrane with a pentafluorophenyl side chain was heat-treated.

TABLE 3

| | | | | | Selectivity (—) | | |
|---|---|---|---|---|---|---|---|
| | Gas Permeability (Barrer) | | | | CO₂/ | CO₂/ | CO₂/ |
| Sample | H₂ | CO₂ | N₂ | CH₄ | H₂ | N₂ | CH₄ |
| pTPPFA | 195 | 280 | 17 | 19 | 1.4 | 16.5 | 14.7 |
| pTPPFA-400 | 516 | 919 | 59 | 69 | 1.8 | 15.6 | 13.3 |
| pTPPFA-450 | 4607 | 11274 | 836 | 727 | 2.4 | 13.5 | 15.5 |
| pTPPFA-500 | 15432 | 30945 | 2009 | 1824 | 2.0 | 15.4 | 17.0 |

TABLE 4

| | | | | | Selectivity (—) | |
|---|---|---|---|---|---|---|
| | Gas Permeability (Barrer) | | | | C₂H₄/ | C₃H₆/ |
| Sample | C₂H₄ | C₂H₆ | C₃H₆ | C₃H₈ | C₂H₆ | C₃H₈ |
| pTPPFA-400 | 107 | 53 | 81 | 12 | 2.0 | 6.8 |
| pTPPFA-450 | 1490 | 510 | 2559 | 341 | 2.9 | 7.5 |
| pTPPFA-500 | 3628 | 1236 | 2868 | 358 | 2.9 | 8.0 |

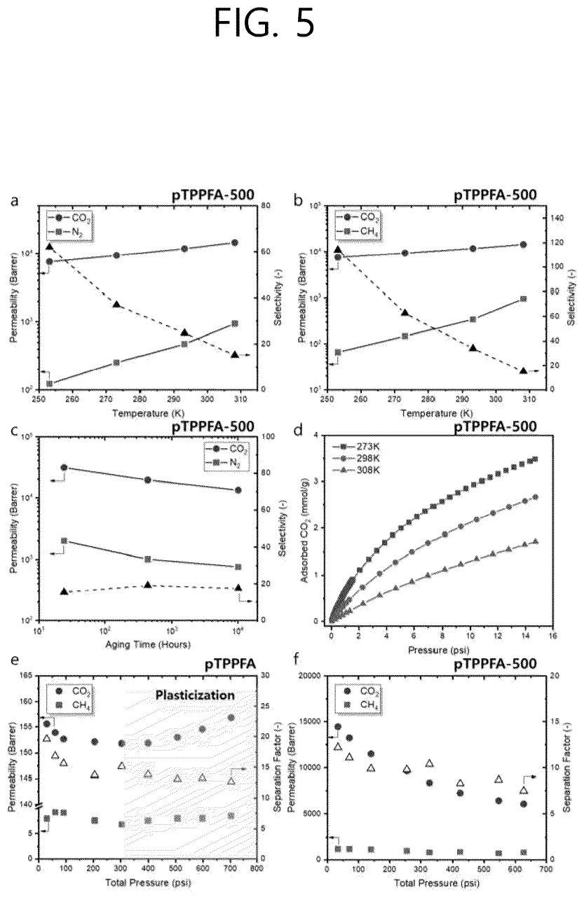

Additionally, the microporous thermally crosslinked polymer membrane according to the embodiments of the present disclosure obtained in Preparation Example 1 was evaluated on the following: the evaluation of the separation performance of CO₂, N₂, CH₄ single gases measured under the conditions of 1 atm, with different temperature of −20° C., 0° C., 20° C., and 35° C.; the evaluation of the separation performance of CO₂ and N₂ single gases to confirm long-term stability under the conditions of 1 atm and 35° C.; CO₂ isothermal adsorption measured at 0° C., 20° C., and 35° C.; and the evaluation of plasticization resistance up to 700 psi using CO₂/CH₄ (50/50 mol) mixed gas, and the results are shown in FIG. 5. The microporous thermally crosslinked polymer membrane was aged in vacuum for 2 weeks or more and then measured in a state where no rapid decrease in gas separation performance was shown.

As shown in FIGS. 5(a) and 5(b), it was confirmed that while pTPPFA-500 membrane showed a decrease in the permeability of CO₂, N₂, and CH₄ as the gas permeability measurement temperature decreased, it showed a dramatic increase in CO₂/N₂ and CO₂/CH₄ selectivity. In particular, according to the results measured at −20° C., it showed excellent gas separation performance having CO₂ permeability of 7,522 Barrer, CO₂/N₂ selectivity of 62, and CO₂/CH₄ selectivity of 114. Since the activation energy of permeation decreases in the order of CH₄>N₂>CO₂, the N₂ and CH₄ permeabilities decreased significantly compared to CO₂ permeability as the measurement temperature decreased. Therefore, the CO₂/N₂ and CO₂/CH₄ selectivity can be greatly increased.

As shown in FIG. 5(c), when the measurement was performed 18 and 424 days after the preparation of pTPPFA-500 membrane, the CO₂ permeability was decreased from the initial 30,945 Barrer to 19,366 Barrer and 13,300 Barrer, respectively. Additionally, the CO₂/N₂ selectivity was increased from the initial 15.4 to 19.1 and 17.5, respectively. This phenomenon occurred because the density of the polymer matrix was increased due to the physical aging of the membrane, but it was confirmed that the resistance to physical aging phenomenon was improved compared to the previously known microporous polymer membranes due to the formation of a crosslinked structure. Specifically, while pTPPFA-500 membrane showed a decrease in permeability by about 57% after 424 days, PIM-1, which is an existing microporous polymer, showed a decrease in permeability of about 69% after 155 days (see Reference Monica Alberto et al., J. of Membrane Sci., 563, 513-520 (2018)).

As shown in FIG. 5(d), pTPPFA-500 membrane showed an excellent amount of CO₂ adsorption of 3.48 mmol/g at 0° C., 2.67 mmol/g at 20° C., and 1.72 mmol/g at 35° C.

As shown in FIGS. 5(e) and 5(f), pTPPFA precursor membrane was observed to undergo a plasticization phenomenon under the condition of about 300 psi of CO₂/CH₄ 50/50 mixed gas, thereby resulting in an increase of gas permeability and a decrease of selectivity. In contrast, pTPPFA-500 membrane did not undergo a plasticization phenomenon even under a high pressure condition of 630 psi, and through this, it can be confirmed that the plasticization resistance of pTPPFA-500 membrane has been dramatically improved.

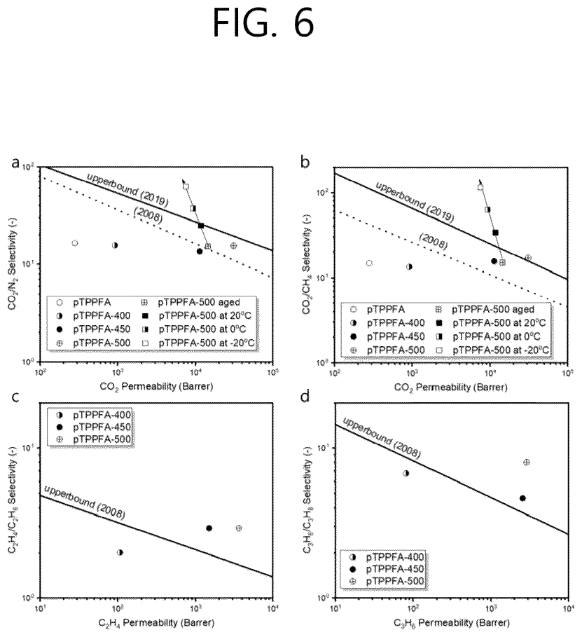

Additionally, various gas separation performances of the microporous thermally crosslinked polymer membrane according to an embodiment of the present disclosure obtained in Preparation Example 1 were compared with Robeson's Upper Bound, which is considered the performance limit of existing polymer membranes, and the results are shown in FIG. 6. In particular, in the case of pTPPFA-500 membrane measured at 35° C., it was confirmed that the CO₂/CH₄, C₂H₄/C₂H₆, and C₃H₆/C₃H₈ separation performances were all superior to the upper bound separation performance of the previously known polymer membranes.

What is claimed is:

1. A microporous crosslinked polymer membrane comprising a thermally crosslinked product of halogenated aromatic polymers, comprising a repeating unit having:
(a) a residue of an aldehyde or ketone having a halogenated aromatic ring; and
(b) a residue of a deactivated aromatic hydrocarbon having multiple aromatic rings.

2. The microporous crosslinked polymer membrane of claim 1, wherein the (a) residue of an aldehyde or ketone having a halogenated aromatic ring is derived from at least one compound shown in Formula 1 below: 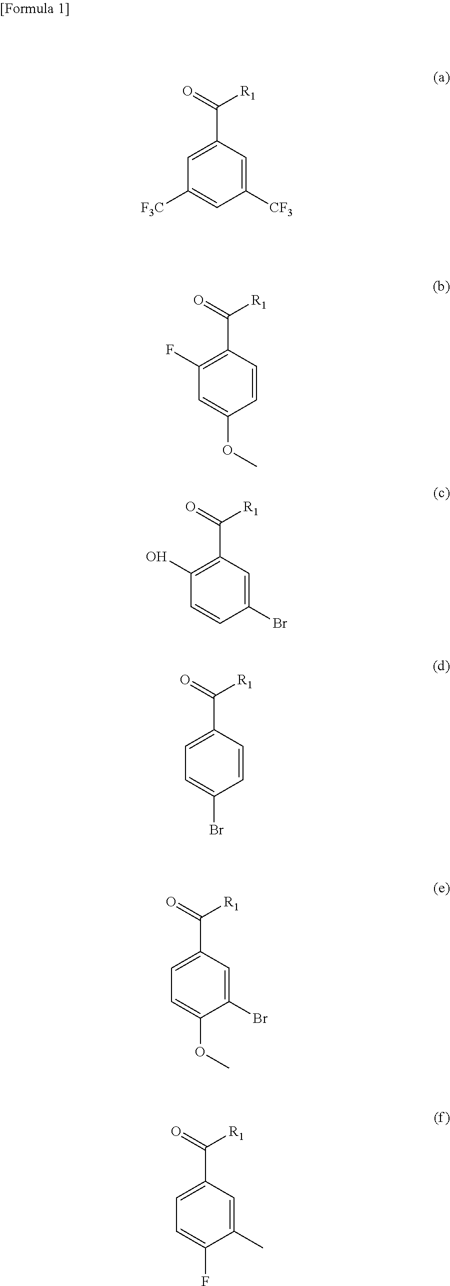 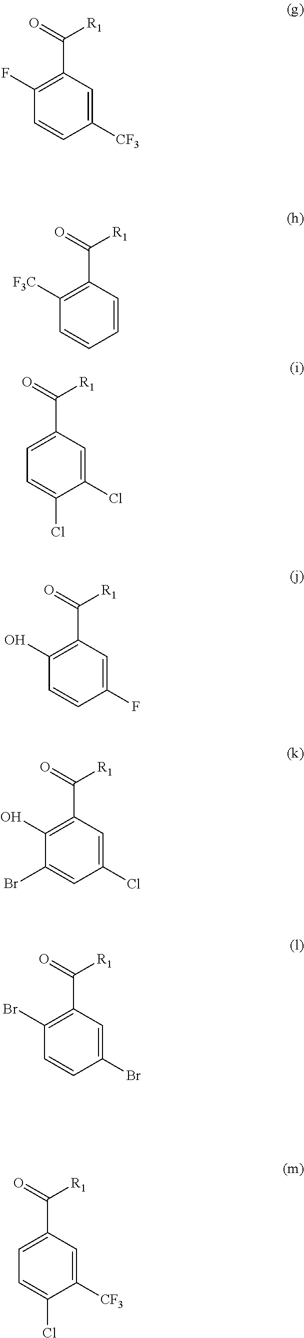 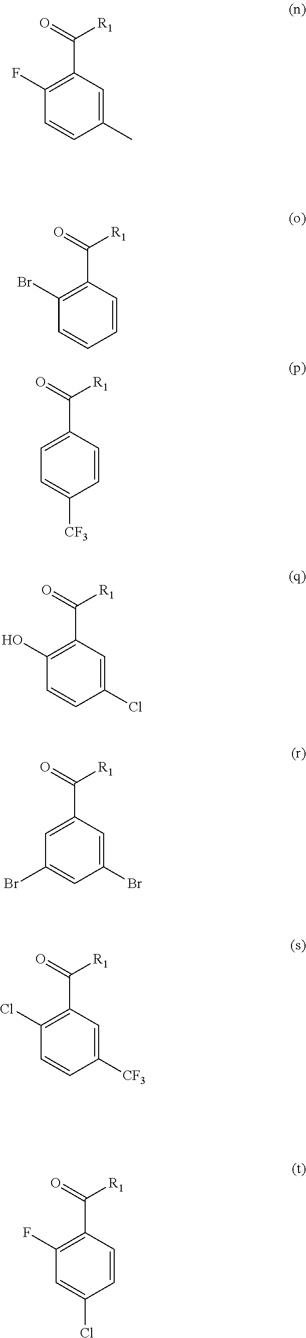 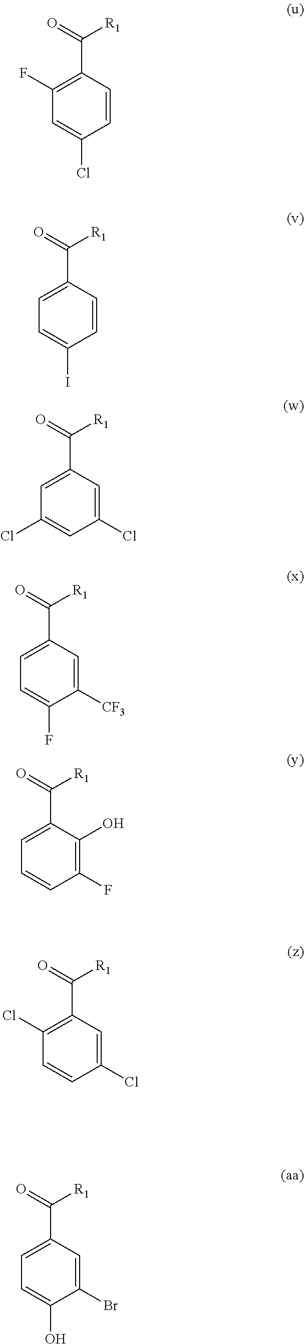 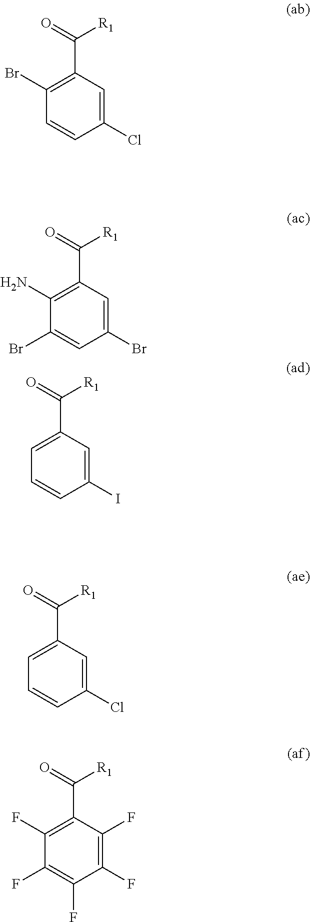
wherein in Formula 1 above, R₁ is C₁₋₂₀ alkyl substituted or unsubstituted with hydrogen or halogen.

3. The microporous crosslinked polymer membrane of claim 1, wherein the (a) residue of an aldehyde or ketone having a halogenated aromatic ring is derived from octafluoroacetophenone.

4. The microporous crosslinked polymer membrane of claim 1, wherein the (b) residue of a deactivated aromatic hydrocarbon having multiple aromatic rings is derived from at least one compound shown in Formula 2 below.

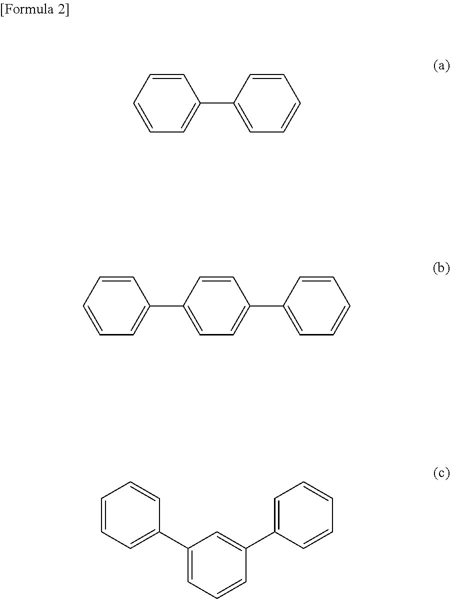

5. The microporous crosslinked polymer membrane of claim 4, wherein the (b) residue of a deactivated aromatic hydrocarbon having multiple aromatic rings multiple aromatic rings is derived from para-terphenyl.

6. The microporous crosslinked polymer membrane of claim 1, wherein the halogenated aromatic polymer has the structure of Formula 3 below: 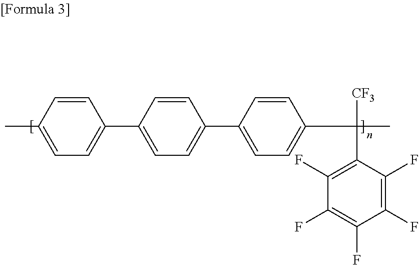 [SMILES: Cc1ccc(-c2ccc(-c3ccc(C(C)(c4c(F)c(F)c(F)c(F)c4F)C(F)(F)F)cc3)cc2)cc1]
wherein in Formula 3 above, n is 50 to 500.

7. The microporous crosslinked polymer membrane of claim 1, wherein the specific surface area calculated using the nitrogen (N₂) adsorption isotherm measured at −196° C. and the Brunauer-Emmett-Teller (BET) equation is 520 m²/g to 1,000 m²/g.

8. The microporous crosslinked polymer membrane of claim 1, wherein the carbon dioxide (CO₂) adsorption amount calculated from the carbon dioxide (CO₂) adsorption isotherm measured at 0° C. is 35 cm³/g to 80 cm³/g.

9. The microporous crosslinked polymer membrane of claim 1, wherein the total pore volume calculated using the nitrogen (N₂) adsorption isotherm measured at −196° C. and the non-local density functional theory (NLDFT) model is 0.20 cm³/g to 0.40 cm³/g.

10. The microporous crosslinked polymer membrane of claim 1, wherein the micropore volume with an average diameter of 2 nm or less calculated using the nitrogen (N₂) adsorption isotherm measured at −196° C. and the non-local density functional theory (NLDFT) model is 0.10 cm³/g to 0.30 cm³/g.

11. The microporous crosslinked polymer membrane of claim 1 having an average thickness of 60 μm to 100 μm.

12. The microporous crosslinked polymer membrane of claim 1, wherein under the conditions of 1 atm and 35° C., the hydrogen permeability is 4,000 Barrer to 16,000 Barrer, the carbon dioxide permeability is 10,000 Barrer to 31,000 Barrer, the nitrogen permeability is 800 Barrer to 21,000 Barrer, and the methane permeability is 500 Barrer to 2,000 Barrer.

13. The microporous crosslinked polymer membrane of claim 1, wherein under the conditions of 1 atm and −20° C., the carbon dioxide permeability is 7,000 Barrer to 9,000 Barrer, the nitrogen permeability is 100 Barrer to 150 Barrer, and the methane permeability is 50 Barrer to 75 Barrer.

14. The microporous crosslinked polymer membrane of claim 1, wherein under the conditions of 2 atm and 35° C., the ethylene permeability is 1,200 Barrer to 4,000 Barrer, the ethane permeability is 400 Barrer to 1,500 Barrer, the propylene permeability is 2,000 Barrer to 3,000 Barrer, and the propane permeability is 250 Barrer to 400 Barrer.

15. The microporous crosslinked polymer membrane of claim 1, wherein under the conditions of 1 atm and 35° C., the carbon dioxide/hydrogen selectivity is 1.0 to 3.0, the carbon dioxide/nitrogen selectivity is 12.0 to 18.0, and the carbon dioxide/methane selectivity is 12.0 to 20.0.

16. The microporous crosslinked polymer membrane of claim 1, wherein under the conditions of 1 atm and −20° C., the carbon dioxide/nitrogen selectivity is 45 to 90 and the carbon dioxide/methane selectivity is 93 to 200.

17. The microporous crosslinked polymer membrane of claim 1, wherein under the conditions of 2 atm and 35° C., the ethylene/ethane selectivity is 2.0 to 5.0 and the propylene/propane selectivity is 6.0 to 10.0.

18. A method for preparing a microporous crosslinked polymer membrane, comprising:
(1) dissolving, in a solvent, the halogenated aromatic polymer, comprising a repeating unit having (a) a residue of an aldehyde or ketone having a halogenated aromatic ring; and (b) a residue of a deactivated aromatic hydrocarbon having multiple aromatic rings;
(2) forming the polymer solution obtained in the step (1) above into a form of a membrane and then removing the solvent; and
(3) thermally crosslinking the membrane obtained in the step (2) above at a temperature of 430° C. to 520° C.

19. The method of claim 18, wherein the solvent in the step (1) above comprises at least one selected from the group consisting of N-methyl-2-pyrrolidone (NMP), tetrahydrofuran (THF), methylene chloride (MC), chloroform (CHCl₃), toluene, and mixtures thereof.

20. The method of claim 18, wherein the thermal crosslinking temperature is 450° C. to 500° C. and the thermal crosslinking time is performed for 0.5 to 3 hours.

21. A method for separating gas, which comprises allowing a mixed gas comprising at least one gas selected from the group consisting of hydrogen, carbon dioxide, nitrogen, methane, ethane, ethylene, propane, and propylene to pass through the microporous crosslinked polymer membrane of claim 1 to thereby partially separate this at least one gas selected from the group consisting of hydrogen, carbon dioxide, nitrogen, methane, ethane, ethylene, propane, and propylene.

22. The method of claim 21, wherein from a mixed gas selected from the group consisting of combinations of hydrogen/carbon dioxide, carbon dioxide/nitrogen, carbon dioxide/methane, ethylene/ethane, and propylene/propane, at least one gas among them is partially separated.
